(19) United States
(12) Patent Application Publication
(10) Pub. No.: US 2009/0033892 A1
(43) Pub. Date: Feb. 5, 2009

(54) DOUBLE EXPOSURE OF A PHOTORESIST LAYER USING A SINGLE RETICLE

(75) Inventors: Oleg Kritsun, Sunnyvale, CA (US); Bruno La Fontaine, Pleasanton, CA (US)

Correspondence Address: DITTHAVONG MORI & STEINER, P.C., 918 Prince St., Alexandria, VA, 22314, US

(73) Assignee: Advanced Micro Devices, Inc., Sunnyvale, CA (US)

(21) Appl. No.: 11/832,799

(22) Filed: Aug. 2, 2007

(51) Int. Cl. G03B 27/42; G03B 27/44

(52) U.S. Cl. 355/46; 355/77

(57) ABSTRACT

A composite exposure image is formed on a photoresist layer by applying a light beam through a reticle to form a first exposure image thereon, and thereafter, while maintaining the position of the reticle with respect to the photoresist layer, again applying a light beam through the reticle to form a second exposure image thereon. By adjusting the light beam differently in focus and intensity for each exposure, the combination of first and second exposure images form a pattern on the photoresist of lesser pitch than can be produced from a single exposure. The formation of a single pattern in the single resist layer from the two exposures avoids misalignment problems and eliminates the need for double exposure of a plurality of resist layers.

### FIELD OF THE INVENTION

The present invention relates to fabrication of semiconductor devices having accurately formed designed features, more particularly to formation of patterns of reduced pitch.

### BACKGROUND

The formation of various integrated circuit (IC) structures on a wafer often relies on lithographic processes, sometimes referred to as photolithography, or simply lithography. As is well known, lithographic processes can be used to transfer a pattern of a photomask (also referred to herein as a mask or a reticle) to a wafer. Patterns can be formed from a photoresist layer disposed on the wafer by passing light energy through a reticle mask to form an image of the desired pattern onto the photoresist layer. As a result, the pattern is transferred to the photoresist layer. In areas where the photoresist is sufficiently exposed, after a development cycle the photoresist material can become soluble such that it can be removed to selectively expose an underlying layer (e.g., a semiconductor layer, a metal or metal containing layer, a dielectric layer, a hard mask layer, etc.). Portions of the photoresist layer not exposed to a threshold amount of light energy will not be removed and will serve to protect the underlying layer during further processing of the wafer (e.g., etching exposed portions of the underlying layer, implanting ions into the wafer, etc.). Thereafter, the remaining portions of the photoresist layer can be removed.

There is a continuing objective to increase the density with which various integrated circuit structures are arranged. To this end feature size, line width, and the separation between features and lines are becoming increasingly smaller. Fabrication in the sub-micron range incurs limitations in faithfully reproducing reticle patterns as exposed images on the photoresist layer. Yield is affected by factors such as mask pattern fidelity, optical proximity effects and photoresist processing.

Nodes with a critical dimension of about 45 nanometers (nm) to about 65 nm have been proposed. In these sub-micron processes, yield is affected by factors such as mask pattern fidelity, optical proximity effects and photoresist processing. These concerns are largely dependent on local pattern density and topology. For example, for a repetitive line pattern, a minimum printable pitch for a single exposure of the photoresist through the mask reticle can be determined. That is, a pitch smaller than the minimum pitch will produce an unacceptable exposure pattern.

One approach for overcoming such problems has been to employ two photoresist layers each subjected to exposure through a reticle. For example, a first resist pattern is formed over a target layer and then the resist pattern may be covered by a cover layer. A second resist pattern can then be formed on the cover layer over the first resist pattern leaving exposed portions of the cover layer. The cover layer can then be selectively etched to remove the exposed portions of the cover layer. A target pattern is defined by the first and second resist patterns. The target pattern may be used as a mask for etching the target layer.

The double exposure techniques of the prior art present difficulties in appropriately overlaying the various layers with each other and with the one or more patterned masks that may be required. The need exists to overcome misalignment problems as well as to streamline the processing involved in the use of a plurality of resist layers to form a resist pattern with a pitch in the deep sub-micron range.

### DISCLOSURE

The above described needs are fulfilled, at least in part, by exposing a photoresist layer to a light beam through a reticle to form a first exposure image thereon, and thereafter, while maintaining the position of the reticle with respect to the photoresist layer, exposing the photoresist layer to a second exposing step to form a second exposure image thereon. The formation of a single pattern in the single resist layer from the two exposures avoids misalignment problems and eliminates the need for double exposure of a plurality of resist layers.

The single pattern resulting from the two different exposure images are obtained by applying a light beam having characteristics that differ for the first and second exposures. By adjusting the light beam differently in focus and intensity for the first exposure and second exposure, a second exposure image can be obtained that is reversal of the first image and is effectively a phase shifted image of the first image. For a reticle pattern having a formation of regularly spaced openings at a determined pitch, the combination of first and second exposure images form a pattern on the resist of lesser pitch than would be produced, such as the minimum printable pitch, from a single exposure through the reticle.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawing and in which like reference numerals refer to similar elements and in which:

FIG. 1 is a schematic block diagram of an integrated circuit processing arrangement.

FIG. 2 is a plan view of an exemplary reticle pattern.

FIG. 3 is a simplified illustration in which image patterns formed by applied beams of different focus can be compared.

FIG. 4 is a matrix illustrative of exposure patterns formed by a range of applied beams of different focus and exposure intensity

FIGS. 5A-5C are exemplary exposure images formed with a reticle such as shown in FIG. 2.

FIG. 6 contains illumination charts for dipole and full pupil illumination sources.

### DETAILED DESCRIPTION

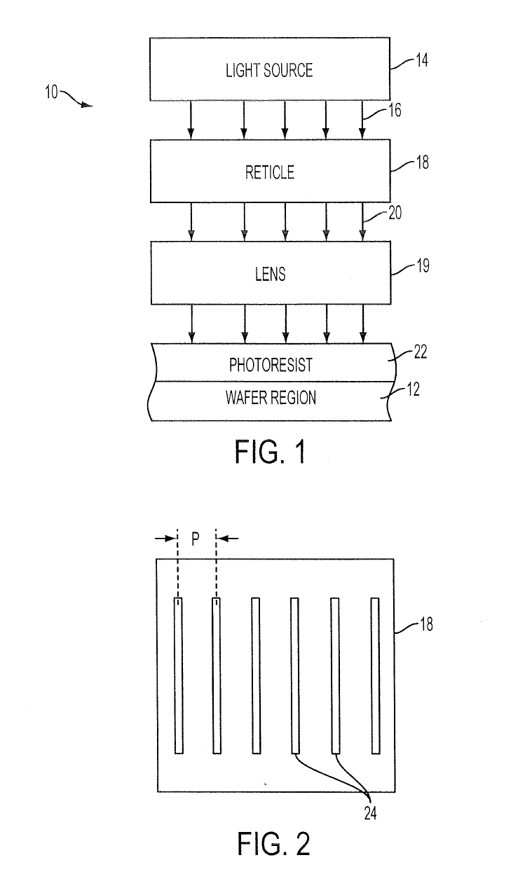

An exemplary processing system 10, used to image a pattern onto a wafer 12, or a region thereof, is shown in FIG. 1. The system 10 can be, for example, a step-and-repeat exposure system or a step-and-scan exposure system, but is not limited to these example systems. Light source 14 directs energy 16 towards reticle 18. The reticle 18 selectively blocks light energy 16 such that a light energy pattern 20 defined by the reticle 18 is transferred through lens 19 toward photoresist 22 that overlays the wafer 12.

FIG. 2 is an exemplary plan view of reticle 18. Line openings 24 are spaced apart at a pitch P. A light applied to this reticle pattern produces a line feature pattern in the photo resist 22. To obtain the greatest integrated circuit density, the pitch P should be the minimum distance that will produce a satisfactory exposure image on the photoresist. This minimum pitch is dependent upon several factors, including among other things, the line width, photoresist characteristics, radiation beam characteristics, and spacing between the reticle and photoresist. For features dimensionally in the deep sub-micron range, the minimum reticle pattern pitch with appropriate focus, for a reticle such as exemplified in FIG. 2, has been found to be approximately 100 nm.

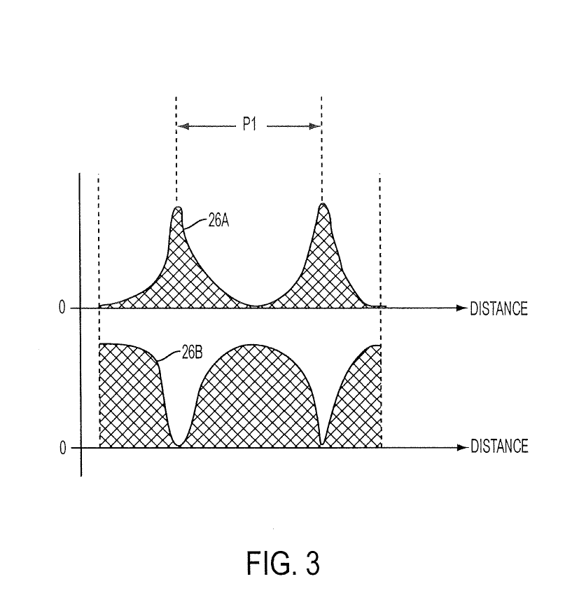

A change in focus of a light beam affects the sharpness of the exposed image on the photoresist, as illustrated in the images depicted in FIG. 3. Exposure image 26A is produced by a sharply focused (taken as 0.0 um reference) light beam that is applied through the reticle 18 to expose the photoresist 22. Reticle 18 is patterned in the arrangement illustrated in FIG. 2. The hatched portions of the image represent the exposure level on the photoresist. High levels of exposure are contained in narrow peaked intervals that correspond to the line pattern of the reticle 18. If the line pitch of the reticle is the minimum pitch, the distance P1 of exposure image 26A is the smallest acceptable pitch that can be obtained for a single exposure.

The focus of the applied light beam can be changed, while maintaining the positional relationship between the reticle and photoresist to produce the exposure image 26B. Image 26B is a reversal of the image 26A. The high levels of exposure are indicated by the wide hatched portions. The resulting image lines of exposure image 26B are considerably wider than the image lines of exposure image 26A. The complete image reversal occurs by application of a light beam of approximately the same intensity level for each exposure.

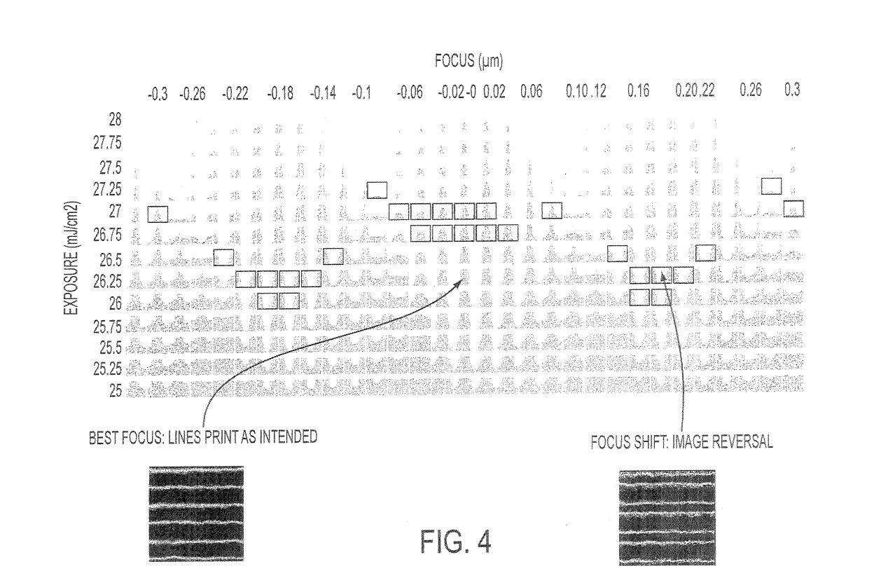

By adjusting focus and level of radiation intensity, the exposure pattern can be changed. FIG. 4 is a focus-exposure matrix showing patterns that have been produced by various combinations of focus and radiation exposure levels. The exposures shown are in a range of 25-28 mJ/cm² in 0.25 mJ/cm² increments. The range of focus extends between −0.3 to +0.3 um in increments of 0.04 um. The range of focus between approximately −0.06 m and +0.06 with an exposure range between approximately 26.75 and 27.0 mJ/cm² yielded the best results for defining line images corresponding to exposure image 26A of FIG. 3. As can be seen from the matrix of FIG. 4, the exposure width for the image 26B of FIG. 3 can be made narrower to define line images. An exposure range of between 26.0 and 26.5 mJ/cm² with two focus ranges yielded the best results for defining image reversal line images corresponding to exposure image 26B of FIG. 3. The best focus ranges were between −0.14 and −0.22 um and between +0.14 and 0.22 um.

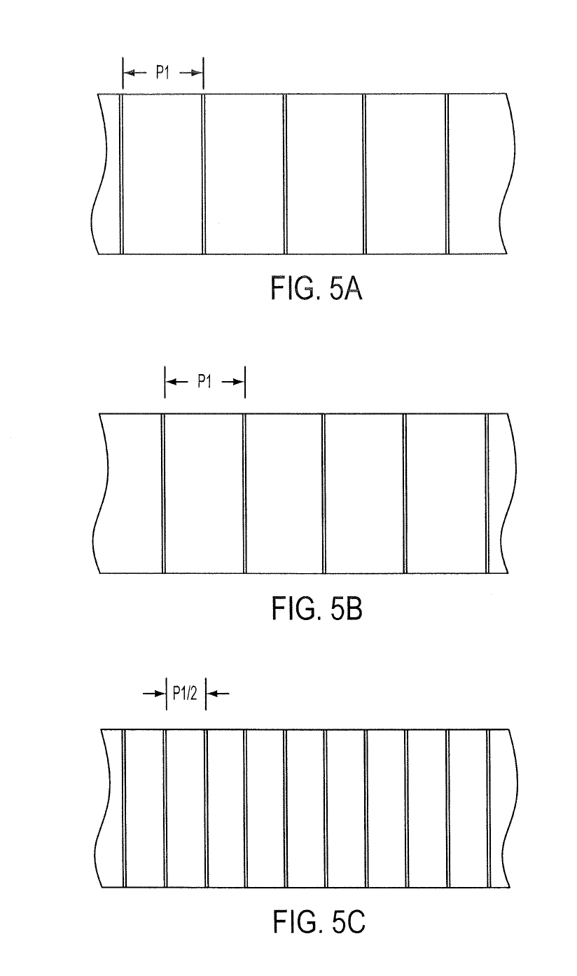

FIGS. 5A-5C represent photoresist exposure images formed by exposing the photoresist through the reticle 18 of FIG. 2. The exposure image of FIG. 5A is obtained by application of a light beam corresponding to the focus and exposure ranges for obtaining the best defined image 26A of FIG. 3, as identified in the above discussion of FIG. 4. The exposure image of FIG. 5B is obtained by application of a light beam corresponding to the focus and exposure ranges for obtaining the best image reversal image 26B of FIG. 3, as identified in the above discussion of FIG. 4.

Each of the exposure images of FIGS. 5A and 5B is a line pattern having a pitch of PI, the images displaced in phase from each other by an amount equivalent to one hundred eighty degrees. FIG. 5C represents an exposure image corresponding to a superposition of the images of FIGS. 5A and 5B. Such a superimposed image can be obtained by exposing the photoresist twice. In the first exposure, a light beam is applied having the characteristics that produce the exposure of FIG. 5A. In the second exposure, a light beam is applied without changing the position of the reticle, the light beam having the characteristics that produce the exposure of FIG. 5B. The resulting superimposed image of FIG. 5C is a line pattern having a pitch that is half that of P1.

The double exposure of the single photoresist, while maintaining the reticle position provides clear advantages. A smaller line pitch is obtained than is possible from application of a single exposure. The use of a single photoresist avoids the necessity of repositioning elements, with the inherent alignment problems, that is intrinsic to a process in which a plurality of photoresist layers are each exposed. In comparison, the presently described process is greatly simplified, while conserving materials. Alternatively, a photoresist having a non-linear characteristic may be used to obtain a modified exposure image. In addition, one or more contrast enhancement layers may be deposited over the photoresist layer to enhance the double exposure process.

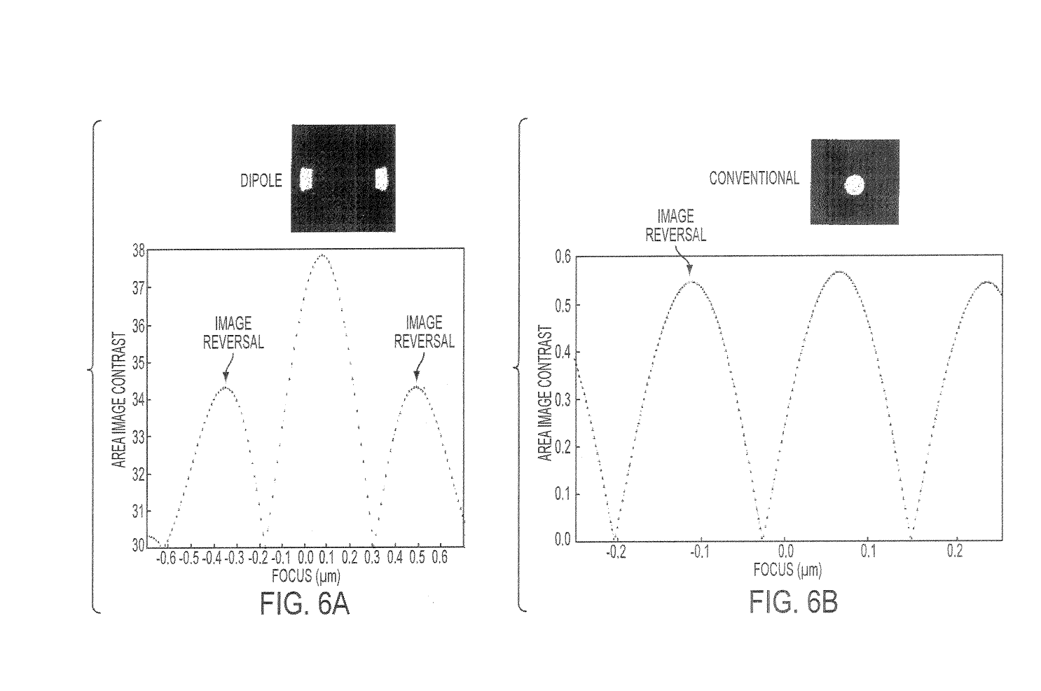

The light source used in the process may employ a well-known conventional illuminator which passes light through the entire pupil or a well-known dipole source, in which light is passed through a peripheral ring of the pupil. A comparison of the attributes of these light sources is represented in the charts of FIG. 6. The dipole source, represented by the left chart, provides a tighter minimum pitch than the conventional source, represented by the right chart. As the dipole requires larger focus offsets, a smaller contrast results for the reversed image portion. The conventional source provides high contrast for the reversed image portion, although providing a slightly higher minimum pitch.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein. For example, the concepts of the present invention are applicable to any of a various patterns other than the exemplary reticle pattern illustrated in FIG. 2

What is claimed is:

1. A method of processing a photoresist mask for defining a targeted pattern on a semiconductor chip comprising the steps of:
constructing a reticle;
positioning the reticle over, and in alignment with, a photoresist layer;
exposing the photoresist layer to a light beam through the reticle to form a first exposure image thereon in a first exposing step;
maintaining the position of the reticle with respect to the photoresist layer established in the positioning step; and
exposing the photoresist layer to a light beam through the reticle to form a second exposure image thereon in a second exposing step.

2. A method as recited in claim 1, wherein the reticle is unchanged during the first and second exposing steps.

3. A method as recited in claim 2, wherein the light beam applied in the second exposing step differs from the light beam applied in the first exposing step.

4. A method as recited in claim 3, wherein the first exposing step comprises adjusting the light beam to a first focus and the second exposing step comprises adjusting the light beam to a second focus.

5. A method as recited in claim 3, wherein the first exposing step comprises setting the light beam at a first intensity level and the second exposing step comprises setting the light beam at a second intensity level.

6. A method as recited in claim 3, wherein the first exposing step further comprises setting the light beam at a first intensity level and the second exposing step further comprises setting the light beam at a second intensity level.

7. A method as recited in claim 4, wherein the step of constructing comprises forming openings in the reticle that are regularly spaced at a predetermined pitch.

8. A method as recited in claim 7, wherein the second exposure image is a reverse image of the first exposure image.

9. A method as recited in claim 8, wherein the predetermined pitch corresponds to a minimum acceptable image for a single exposure of the photoresist layer.

10. A method as recited in claim 9, wherein the first exposure image and the second exposure image form a composite image having a pitch smaller than the minimum printable pitch.

11. A method as recited in claim 10, wherein the predetermined pitch is approximately 100 nm.

12. Apparatus comprising:
a patterned reticle configured to be positioned over, and in alignment with, a photoresist layer;
a light source configured to illuminate the photoresist layer through the reticle, successively, to form first and second different exposure images thereon while the position of the patterned reticle with respect to the photoresist layer is maintained.

13. Apparatus as recited in claim 12, wherein the reticle comprises a formation of openings that are regularly spaced at a predetermined minimum pitch.

14. Apparatus as recited in claim 13, wherein the first and second exposure images are phase shifted with respect to each other.

15. Apparatus as recited in claim 12, wherein the light source comprises a first light beam for obtaining the first exposure image and a second light beam for obtaining the second exposure image, the first and second light beams differing from each other.

16. Apparatus as recited in claim 15, wherein the first and second light beams comprise different focus positions for exposure.

17. Apparatus as recited in claim 15, wherein the first and second light beams are of different intensities.

18. Apparatus as recited in claim 13, wherein the first exposure image and the second exposure image form a composite image having a pitch smaller than the predetermined minimum pitch.

19. Apparatus as recited in claim 12, wherein the second exposure image is a reverse image of the first exposure image.

20. Apparatus as recited in claim 14, wherein the predetermined minimum pitch is approximately 100 nm.
